(19) United States
(12) Patent Application Publication
(10) Pub. No.: US 2014/0223271 A1
(43) Pub. Date: Aug. 7, 2014

(54) SYSTEMS AND METHODS OF CREATING AN ANIMATED CONTENT ITEM

(71) Applicant: Google Inc., (US)

(72) Inventor: NATE RACKLYEFT, San Francisco, CA (US)

(73) Assignee: Google Inc., Mountain View, CA (US)

(21) Appl. No.: 13/758,395

(22) Filed: Feb. 4, 2013

(51) Int. Cl. G06F 17/22

(52) U.S. Cl. CPC G06F 17/2247
USPC 715/201

(57) ABSTRACT

Systems and methods of creating animated content items via a computer network are provided. A data processing system can provide a content generation application to a computing device via the computer network. The content generation application can have at least one interface configured to prompt for a first frame and a second frame. The content generation application, executed by at least one of the data processing system or the computing device, can determine a characteristic of an object in the first frame and the characteristic of the object in the second frame. A difference between the characteristic of the object in the first frame and the characteristic of the object in the second frame can be further determined. Based on the difference, an animation instruction can be generated. An animated content item, using the animation instruction, can then be generated.

### BACKGROUND

In a computer networked environment such as the internet, entities such as people or companies provide information for public display on documents such as web pages. The documents can include first party information provided by the entities via a web page server for display on the internet. Third party content can also be provided by third parties for display on these documents together with the first party information. Thus, a person viewing a document can access the first party information that is the subject of the document, as well as third party content that may or may not be related to the subject matter of the document.

### SUMMARY

At least one aspect is directed to a computer-implemented method of creating animated content items via a computer network for display at computing devices as part of an online content item placement campaign. The method includes providing a content generation application from a data processing system to a computing device via the computer network. The content generation application can have at least one interface configured to prompt for a first frame and a second frame. The method includes determining by one of the data processing system and the computing device, a characteristic of an object in the first frame and the characteristic of the object in the second frame. The method further includes determining a difference between the characteristic of the object in the first frame and the characteristic of the object in the second frame. The method also includes generating, by the content generation application and during execution of the content generation application by at least one of the data processing system and the computing device, an animation instruction based on the difference between the characteristic of the object in the first frame and the characteristic of the object in the second frame. The method also includes generating an animated content item using the animation instruction, and selecting the animated content item as a candidate for display by a client computing device as part of the online content item placement campaign.

At least one aspect is directed to a system of creating animated content items via a computer network for display at computing devices as part of an online content item placement campaign. The system includes a data processing system configured to provide a content generation application to a computing device. The content generation application can have at least one interface configured to prompt for a first frame and a second frame. The content generation application can determine a characteristic of an object in the first frame and the characteristic of the object in the second frame, and can determine a difference between the characteristic of the object in the first frame and the characteristic of the object in the second frame. The content generation application can generate, by the content generation application during execution of the content generation application by at least one of the data processing system and the computing device, an animation instruction based on the difference between the characteristic of the object in the first frame and the characteristic of the object in the second frame. The content generation application can generate an animated content item using the animation instruction, and the data processing system can select the animated content item as a candidate for display by a client computing device as part of the online content item placement campaign.

At least one aspect is directed to a computer readable storage medium storing instructions that when executed by one or more data processors, cause the one or more data processors to perform operations for creating animated content items for display at computing devices as part of an online content item placement campaign. The operations include providing a content generation application having at least one interface configured to prompt for a first frame and a second frame. The operations include determining a characteristic of an object in the first frame and the characteristic of the object in the second frame, and determining a difference between the characteristic of the object in the first frame and the characteristic of the object in the second frame. The operations further include generating, by the content generation application and during execution of the content generation application by at least one of a data processing system and a computing device, an animation instruction based on the difference between the characteristic of the object in the first frame and the characteristic of the object in the second frame. The operations also include generating an animated content item using the animation instruction. The operations also include selecting the animated content item as a candidate for display by a client computing device as part of the online content item placement campaign.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting an example system of creating animated content items via a computer network, according to an illustrative implementation;

FIG. 2 is an example display for creating animated content items, according to an illustrative implementation;

FIG. 3 is an example display for creating animated content items, according to an illustrative implementation;

FIG. 4 is an example display for creating animated content items, according to an illustrative implementation;

FIG. 5 is a block diagram illustrating an example system of creating animated content items according to an illustrative implementation;

FIG. 6 is a block diagram depicting an example system of creating animated content items according to an illustrative implementation;

FIG. 7 is a flow diagram depicting an example method of creating animated content items according to an illustrative implementation; and

FIG. 8 is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, methods, apparatuses, and systems for creating animated content items via a computer network. The various concepts introduced above and discussed in greater detail below may be implemented in any of numerous ways, as the described concepts are not limited to any particular manner of implementation. Examples of specific implementations and applications are provided primarily for illustrative purposes.

The present disclosure is directed generally to systems and methods of creating animated content items, such as animated ads as part of an online content item placement campaign. A content provider (e.g., an advertiser) can access a content generation application in order to create the animated content items. For example, a data processing system (e.g., an ad server) can provide the content generation application to a content provider computing device. The content generation application can include an interface configured to prompt the content provider using the content provider computing device to enter frames of the animated content item. The frames can include scenes having objects, such as a car that is the subject of the animated content item. The car, or other objects or portions of objects, can be in different positions in different frames. For example, the car may be at the right side of a first frame and a left side of a second frame.

The content generation application (or other application executing on the data processing system or the content provider computing device) can determine characteristics or properties of the objects in the frames. For example, the characteristics can include the position, rotation, size, scale, or opacity of objects in the frames. In the above example, the content generation application can determine a position (e.g., pixel based or using X,Y or Cartesian coordinates) of the car in each of the two frames.

A delta, or difference between the position (or other characteristic) of the object between frames can also be determined. For example, the content generation application can determine a vector distance, trajectory, rotational distance, or other distance indicator between the object in the first frame and the object in the second frame. From this difference, the content generation application can generate an animation instruction, such as a movement or translation command to move the object in an animated sequence from its position in the first frame to its position in the second frame. Using the animation instruction, the content generation (or other) application can generate an animated content item from the frames received as input by the content provider. The animated content item can be selected by the data processing system as a candidate for placement on web pages or other online documents that can be displayed on computing devices via the computer network.

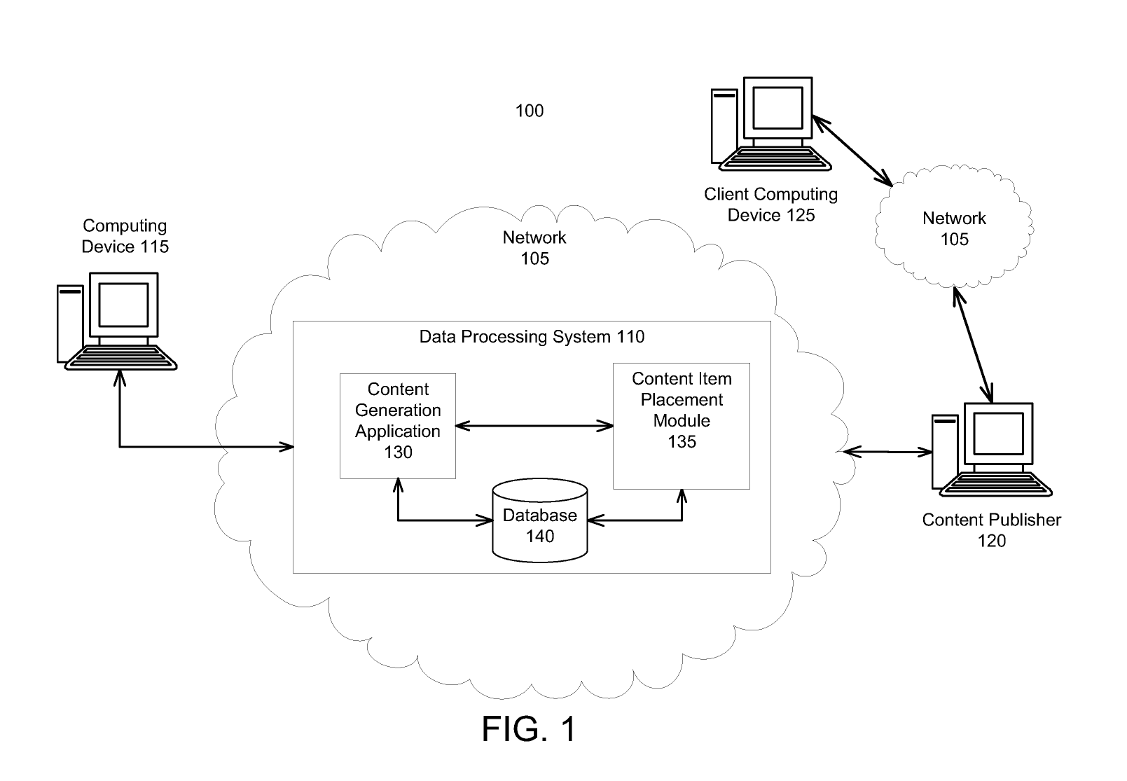

FIG. 1 is a block diagram depicting an example system 100 of creating animated content items via a computer network, such as the network 105. The system 100 can also include at least one data processing system 110, at least one computing device 115, at least one content publisher 120, and at least one client computing device 125. The data processing system 110 can include at least one content generation application 130, at least one content item placement module 135, and at least one database 140.

The network 105 can be any form of computer network that can relay information between various combinations of the data processing system 110, the computing device 115, the content publisher 120, and the client computing device 125. For example, the network 105 can include the Internet, local, wide, metro, other area networks, intranets, satellite networks, other computer networks such as voice or data mobile phone communication networks, and combinations thereof. The network 105 can include hardwired and/or wireless connections. For example, the client computing device 125 can communicate wirelessly (e.g., via radio, cellular, WiFi, Bluetooth, etc.) with a transceiver that is hardwired to other computing devices in network 105. For instance, the network 105 may include a cellular network utilizing any protocol or protocols to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”).

The data processing system 110 can include at least one logic device such as a computing device having a processor to communicate via the network 105, for example with the computing device 115, the content publisher 120, or the client computing device 125. The data processing system 110 can include at least one server. For example, the data processing system 110 can include a plurality of servers located in at least one data center or server farm. In one implementation, the data processing system 110 includes a content placement system to select animated or other content items for display by client computing devices 125, for example with information resources such as web pages or other online documents.

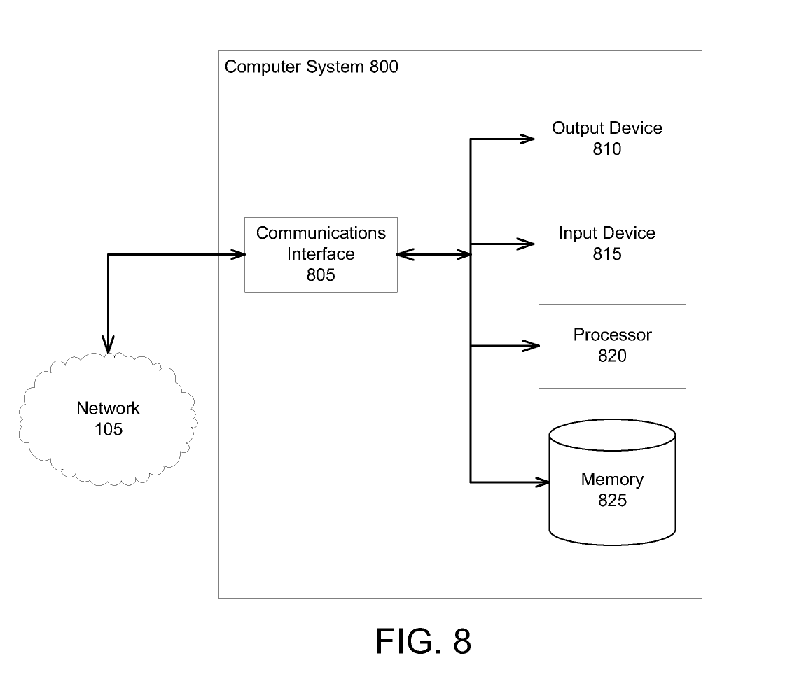

The data processing system 110 can include at least one content generation application 130. The content generation application 130 can include computer software (e.g., a computer program or script) embodied on a tangible medium that can be executed by a computer system, such as the computer system 800 (described herein with reference to FIG. 8). The computer system 800 generally includes a processor or other logic devices that can be part of the data processing system 110 or the computing device 115. In some implementations, the content generation application 130 can be executed at the data processing system 110, the computing device 115, or both. For example, the content generation application 130 can be executed at the computing device 115 to generate animated content items from a set of frames or other images that include objects.

In one implementation, the data processing system 110 can provide the content generation application 130 to the computing device 115 subsequent to receiving a request to create animated content items. For example, the data processing system 110 may receive from the computing device 115 a request to create one or more animated content items, which may be part of an online content item placement campaign. Responsive to this request, the data processing system 110 can provide the content generation application 130 to the computing device 115 to assist the content provider with the creation of animated content items. In one implementation, rather than providing the content generation application 130 to the computing device 115, the data processing system 110 provides the computing device 115 with access to the content generation application 130, which can be executed by the data processing system 110 in this example.

In some implementations, the content generation application 130 can include both a client-side application and a server-side application. For example, a client-side content generation application 130 can be written in one or more programming languages (e.g., JavaScript™, HyperText Markup Language (HTML), Cascading Style Sheet (CSS), or other languages) and can be executed by the computing device 115. The server-side content generation application 130 can be written, for example, in one or more general purpose programming languages, such as C, Go, JavaScript™, or a concurrent programming language, and can be executed by the data processing system 110.

The data processing system 110 can include at least one content item placement module 135. The content item placement module 135 can include at least one processing unit, server, circuit, engine, or other logic devices such as programmable logic arrays. The content item placement module 135 can be configured to communicate with the database 140 and with other computing devices (e.g., the computing device 115, the content publisher 120, or the client computing device 125) via the network 105. In one implementation, the content item placement module 135 can select one or more animated content items generated by the content generation application 130 as candidates for placement on web pages or other information resources displayed at the client computing device 125.

The data processing system 110 can include at least one database 140. The database 140 can include data structures for storing information such as the content generation application 130, animated or other content items, or additional information. The database 140 can be part of the data processing system 110, or a separate component that the data processing system 110 or the computing device 115 can access via the network 105. The database 140 can also be distributed throughout the system 100. For example, the database 140 can include multiple databases associated with the computing device 115, the data processing system 110 or both. In one implementation, the computing device 115 includes the database 140.

The computing device 115 can include servers or other computing devices operated by, for example, a content provider entity to generate animated or other content items using the content generation application 130. For example, and as discussed further herein, the content generation application 130 (executing at the computing device 115 or the data processing system 110) can provide an interface for display at the computing device 115. Data entered via the interface can be processed by the content generation application 130 to generate the animated content items. For instance, the content generation application 130 can generate an animated content item based on frames or scenes (e.g., images including objects in various positions) entered into the interface of the content generation application 130 by the computing device 115.

The computing device 115, (or the data processing system 110) can select the animated content items as candidates for display on information resources such as a web page of the content publisher 120 at the client computing device 125. For example, using input received from the computing device 115, the content generation application 130 can create an animated content item. The data processing system 110 can store the animated content item in the database 140. In this example, the computing device 115 (or the data processing system 110) can retrieve the animated content item from the database 140 and provide it for display at the client computing device 125, for example in a content slot of a web page.

The content publisher 120 can include servers or other computing devices operated by a content publisher entity to provide primary content for display via the network 105. For example, the content publisher 120 can include a web page operator who provides primary content for display on a web page (or other online document or information resource). The primary content can include content other than the third party content (e.g., animated content items). For example, a web page can include content slots configured for the display of third party content items (e.g., animated advertisements) that are generated by the content generation application 130 based on input from the computing device 115. The content publisher 120 can operate the website of a company and can provide content about that company for display on web pages of the website together with animated content items or other third party information.

The client computing device 125 can communicate via the network 105 to display data such as the content provided by the content publisher 120 (e.g., primary web page content) as well as animated content items (e.g., generated by the content generation application 130). The client computing device 125 can include desktop computers, laptop computers, tablet computers, smartphones, personal digital assistants, and other computing devices. The client computing device 125 can include user interfaces such as microphones, speakers, touchscreens, keyboards, pointing devices, a computer mouse, touchpad, or other input or output interfaces.

In some implementations, the client computing device 125 communicates with the content publisher 120 via the network 105 to request access to a web page or other information resource of the content publisher 120 for rendering at the client computing device 125. In this example, the content publisher 120 (or the client computing device 125) can communicate with the data processing system 110 to request third party content for display with the web page at the client computing device 125. The data processing system 110 (or a component such as the content item placement module 135) can select an animated content item responsive to this request. The animated content item can be retrieved from the database 140 (e.g., by the content item placement module 135 or the computing device 115) and provided via the network 105 for display at the client computing device 125, for example in a content slot of the web page as the web page is rendered at the client computing device 125.

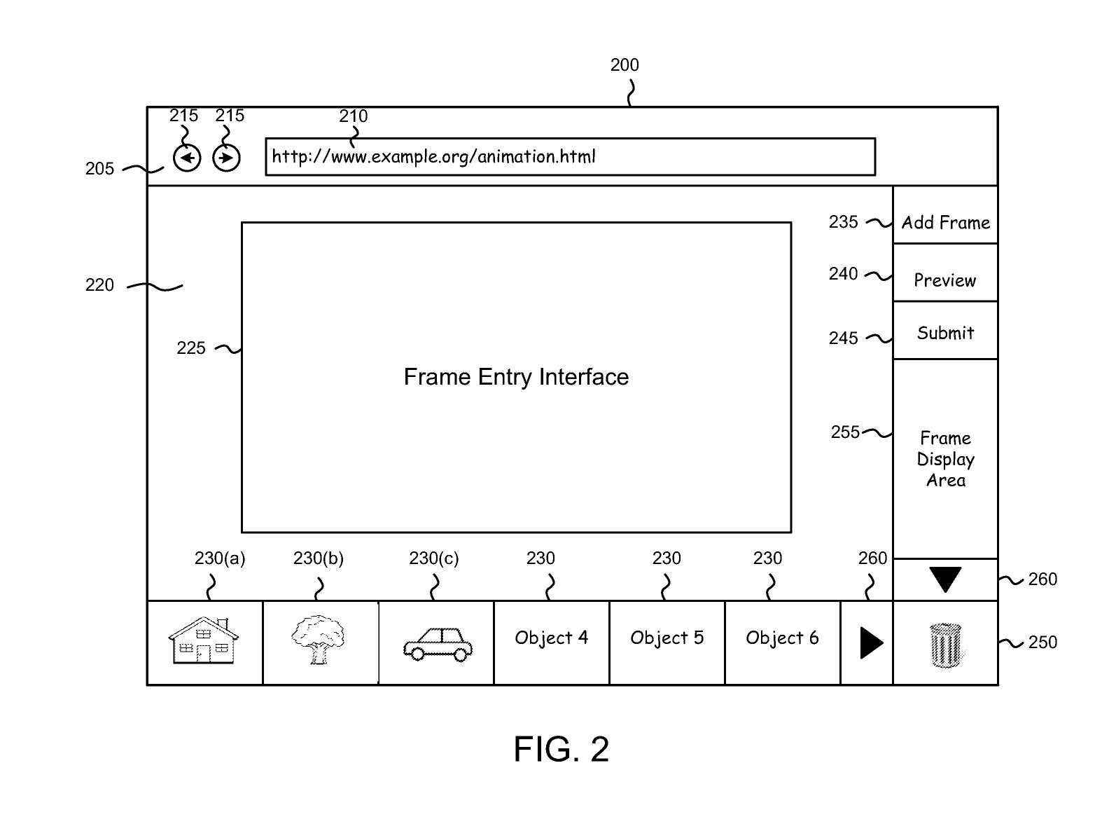

FIG. 2 illustrates an example display 200 provided at the computing device 115 by execution of the content generation application 130 to generate animated content items. Generally, the display 200 can be rendered at the computing device 115 to prompt for data used by the content generation application 130 to create at least one animated content item. For example, the content provider (a user or human operator) using the computing device 115 can enter a series of frames into an interface of the display. Each frame can include objects and represent at least part of a scene of an animated content item. The objects can be selected from an inventory (e.g., provided by the content generation application 130 or the database 140) or can be provided by the content provider.

The display 200 can include a plurality of interfaces and objects. For example, the content generation application 130 can execute to provide the display 200 with at least one frame entry interface 225, at least one object 230, at least one add frame input 235, at least one preview input 240, at least one submit input 245, at least one delete input 250, at least one frame display area 255, or at least one scroll input 260. These inputs 225-260 can include links, buttons, interfaces or inputs provided as part of the display 200 (e.g., within the interface area 220) that, when activated, provide input to the content generation application 130 to perform the operations described herein. The object 230 can include multiple objects, for example, the object 230 can include a house object 230(a), a tree object 230(b), or a car object 230(c). The “object 4” “object 5” and “object 6” placeholders illustrated in the example of FIG. 2 are generic indicators of any object. These objects can be any image, such as a picture, a screenshot, a thumbnail, an image, or a background, for example.

The content generation application 130 can execute at the computing device 115, the data processing system 110, or both to provide the display 200 at the computing device 115. In one implementation, the display 200 can be provided within a web browser 205. In another implementation, the content generation application 130 executes to provide the display 200 at the computing device 115 without utilizing the web browser 205.

In one implementation, an application executed by the computing device 115 can cause the web browser 205 to display on a monitor or screen of the computing device 115. The web browser 205 operates by receiving input of a uniform resource locator (URL) into a field 210 from an input device (e.g., a pointing device, a keyboard, a touchscreen, or another form of input device). In response, the computing device 115 executing the web browser 205 may request data such as the content generation application 130 from a server such as the data processing system 110 corresponding to the URL via the network 105. The data processing system 110 may then execute the content generation application 130 (or provide the content generation application 130 to the computing device 115 for execution) to provide the display 200 at the computing device 115. The web browser 205 may include other functionalities, such as navigational controls (e.g., backward and forward buttons 215).

The display 200 can include a plurality of interfaces to present or prompt for information used by the content generation application 130 to generate the animated content items. For example, the display 200 can include an interface area 220 that can include one or more frame entry interfaces 225 that can receive as input frames (e.g., still images or individual scenes) used to create animated content items. For example, a content provider using the computing device 115 can provide an image frame (scenes, images, or objects 230 that may include video, text, or audio) to the content generation application 130 by clicking and dragging, dropping, inserting, or attachment operations into the frame entry interface 225. In one implementation, the display 200 can prompt users at the computing device 115 to enter a first frame and a second frame. For example, a frame (e.g., a scene) can include a drawing or image defining the starting, intermediary, or ending point of an animation sequence of the animated content item. A frame can include multiple objects, such as a ball, a sky, a person, a product, text, words, or images. The content generation application 130 can control the display 200 to prompt for multiple frames concurrently or sequentially. For example, the display 200 can prompt for a second frame subsequent to a first frame.

In one implementation, the display 200 can include at least one frame entry interface 225. For example, a content provider (e.g., user) at the computing device 115 can click and drag, drop, or insert objects 230 or other objects into the frame entry interface 225 to create a frame. A frame can include a scene composed of one or more of the objects 230. For example, the frame entry interface can receive a frame that includes selections from the set of objects 230, such as a frame having the house object 230(a), tree object 230(b), or car object 230(c). In one implementation, the objects 230 can be stored in the database 140 and provided with the content generation application 130 from the data processing system 110 to the computing device 115 via the network 105. In another implementation, the objects 230 can be obtained by and stored at the computing device 115. In some implementations, the content generation application 130 executes to provide the display 200 with an insert menu or button to prompt for the insertion of the objects 230 into the frame entry interface 225.

The interface area 220 can include at least one add frame input 235 (e.g., a button) that when clicked or accessed causes the content generation application 130 to display an entered frame in the frame display area 255 and to store the entered frame in the database 140 or in a data storage unit of the computing device 115. The frame display area 255 can display one or more stored frames, e.g., as a thumbnail or preview view, or can indicate that previously generated frames exist without displaying them. In some implementations, a second frame can be entered into the frame entry interface 225 with the first frame displayed in the frame display area 255. The second frame can have different objects 230 than the first frame, or the same objects 230 as the first frame, but with the objects 230 in the first and second frames located in different positions or having different appearances, for example, rotated views of the objects, different perspectives, or different color characteristics (e.g., opacity, luminance, hue, saturation, or chromaticity). The preview input 240, when activated, can cause the content generation application 130 to generate a preview of the animated content item, where objects 230 are put in motion in an animated sequence between positions (e.g., location) or characteristics (e.g., opacity) of more than one frame.

The interface area 220 can include at least one submit input 245 that when clicked, can cause the content generation application 130 to store the frame in the database 140 or a data storage unit of the computing device 115. The interface area 220 can also include at least one delete input 250 to delete selected objects 230 or frames. The interface area 220 can also include at least scroll input 260 for displaying additional objects 230 or additional frames in the frame display area 255. The display 200 may also include other objects or functionalities such as menus for setting the size of the frame, or the size, location, or opacity of the objects 230.

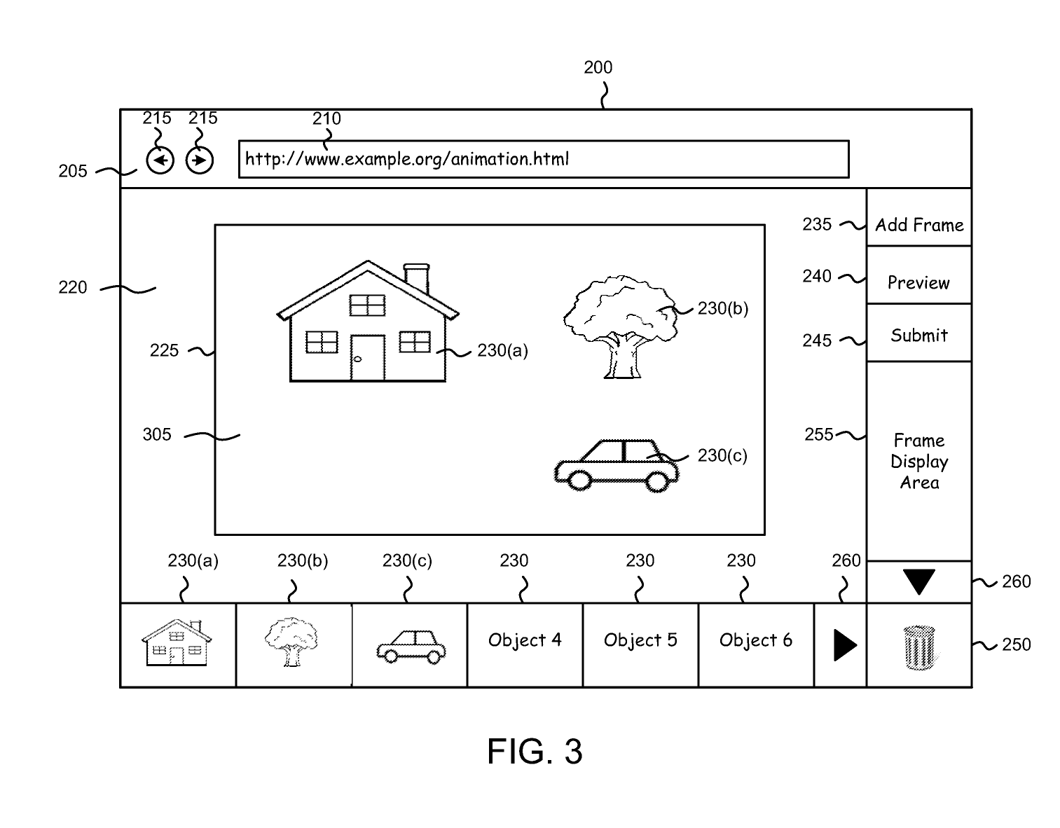

FIG. 3 illustrates an example of the display 200 with a first frame 305 displayed in the frame entry interface 225. In one implementation, the content provider at the computing device 115 enters objects 230 into the frame entry interface 225 to create the first frame 305. For example, a content provider such as a car company can use the content generation application 130 to create an animated content item about cars as part of an online or computer network based ad campaign. In this example, the content provider at the computing device 115 can select and drag the objects 230 into the frame entry interface 225. In the example of FIG. 3, a house object 230(a), a tree object 230(b), and a car object 230(c) can be placed at different locations in the frame entry interface 225 to create the first frame 305. The objects 230 can be provided by the content provider, such as from a memory storage unit of the computing device 115. In one implementation, once the user at the computing device 115 has populated the frame entry interface 225 with objects 230 to create the first frame, the user at the computing device 115 can create a second frame at the display 200. For example, the user may click the add frame input 235 to instruct the content generation application 130 to store the first frame and prompt for entry of a second frame into the frame entry interface 225. In one implementation, activation of the add frame input 235 (e.g., clicking an add frame button) can cause the content generation application 130 to save the first frame 305 and prepare the frame entry interface 225 for receipt of another frame. For example, the first frame 305 can be saved by the content generation application 130 and moved to the frame display area 255 or stored in the database 140. In one implementation, the first frame 305 and the second frame 405 have at least one object 320 in common, that appears at least in part on both frames.

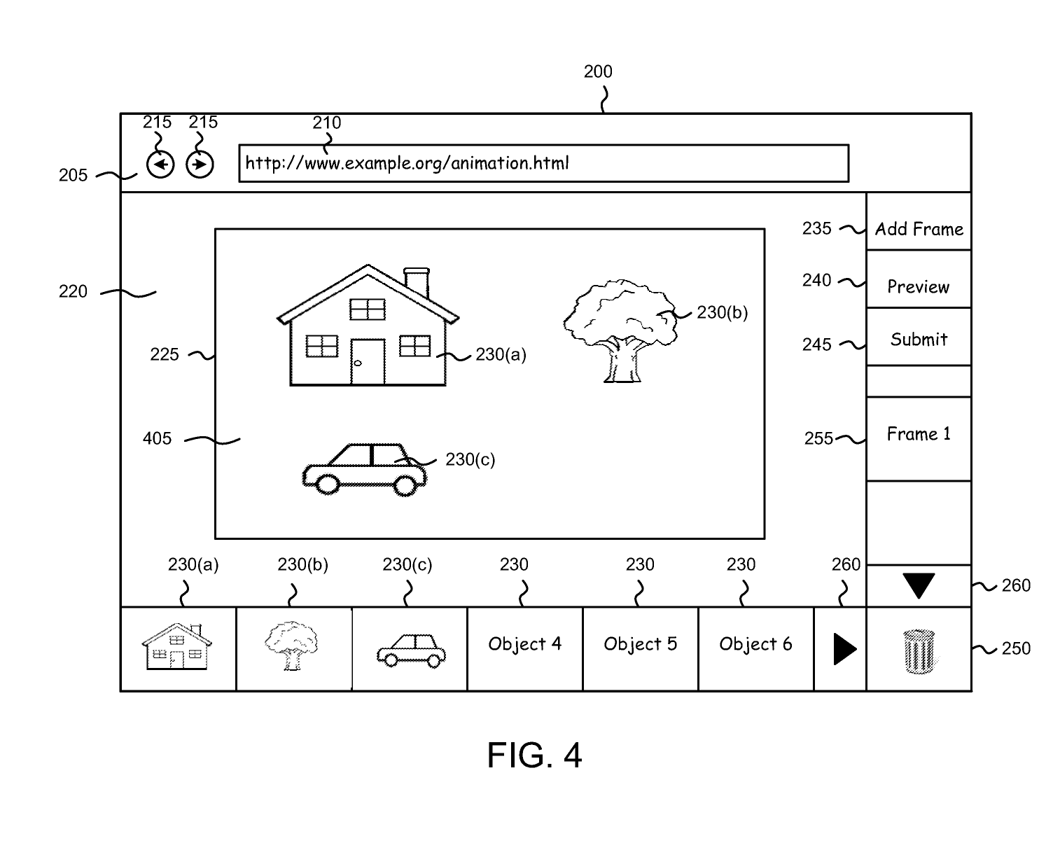

FIG. 4 illustrates an example of the display 200 with a second frame 405 displayed in the frame entry interface 225. In one implementation, subsequent to creation of the first frame 305, the frame entry interface 225 can receive objects 230 that form a second frame. The objects 230 in the first frame 305 and in the second frame 405 can be the same or different, and can be in the same or different locations or have the same or different characteristics. For example, referring to FIGS. 3 and 4, the first frame 305 and the second frame 405 both include the house (object 230(a)) the tree (object 230(b)) and the car (object 230(c)). In this example, the objects 230(a) and 230(b) are in the same position in the first frame 305 and the second frame 405, and the object 230(c) is in a different position in these two frames, as the car (object 230(c)) is in the lower right portion of the first frame 305 and the lower left portion of the second frame 405.

The content provider, using the computing device 115, can add new objects 230 to the frame entry interface 225 or can make changes to the objects 230 from the first frame 305 in order to provide the information used to create the second frame 405. For example, the content provider (e.g., a human operator) at the computing device 115 can change the position of the car 230(c) by selecting and dragging the car 230(c) from the right side of the first frame 305 to a different position (e.g., the left side of the frame as in the second frame 405). Relative to a position in the first frame 305, objects 320 can be rotated, made larger or smaller, or have different opacity values or other characteristics. In some implementation, the opacity, delay, and duration of an object can be set by using a menu provided by the content generation application 130.

The frames can be static or dynamic. For example, the first frame 305 can be a static frame such as an image including one or more objects 230 associated with positional information that indicates the location of the objects 230 within the frame. The frame can also be dynamic. For example the objects 230 in a dynamic frame can include instructions corresponding to the characteristics of the objects 230. In this example, an object 230 (e.g., an image such as a windmill) can appear as a still image in a frame (e.g., the first frame 305) and be imparted with a rotational or other motion based characteristic (e.g., translational, fade, or distal travel). The content generation application 130 can identify the rotational characteristic based on a form of input of the object 230 into the frame entry interface 225. For example, a windmill object 230 can be entered into the frame entry interface 225 with a rotational characteristic based on a pointing tool (or finger on a touchscreen of the computing device 115) making a circular motion with or over the windmill object 230. In this example, the content generation application 130 can determine that the windmill object 230 or portion thereof such as the blades are to rotate during display of an animated content item with another portion of the object 230 remaining motionless.

The content generation application 130 when executed can determine characteristics or properties of the objects 230. For example, a characteristic of an object 230 in the first frame 305 and the characteristic of the same object 230 in the second frame 405 can be determined. Characteristics of the objects 230 can include, for instance, a position characteristic, a rotation characteristic, a size characteristic, or an opacity characteristic. For example, an object's position in a frame can be determined on a pixel basis by its X and Y Cartesian coordinates in the frame. In one implementation, the X and Y coordinates of the object 230 in the frame can be measured by their pixel distance, e.g., from the (0, 0) position starting from a corner of the frame. For example, an object's rotation can be determined by its X and Y Cartesian coordinates in the frame in relation to a midpoint of the object or the Z-axis of the object if 3-dimensional. For example, an object's size in a frame can be determined by the object's dimensions (e.g., length, width, and height if 3-dimensional) on a pixel basis. The content generation application 130 can determine the opacity of objects 230, for example, by determining opacity values of the object 230 in frames where the object 230 appears. For example, an opacity value can range on a scale of zero to one, where zero indicates that the object 230 is transparent and one indicates that the object 230 is opaque.

The content generation application 130 can be executed by the data processing system 110 or the computing device 115 to determine a difference between the characteristic of the object in different frames. For example, the content generation application 130 can determine a difference or delta between the characteristic of the object 230 in the first frame 305 and the characteristic of the same object 230 in the second frame 405, or any other frame. The difference or delta may include a positional change metric, a rotational change metric, a size change metric, or an opacity change metric, for example. For example, the data processing system 110 or the computing device 115 may determine a vector distance, a trajectory, a rotational distance, or other distance indicator between the object 230 in the first frame 305 and the object 230 in the second frame 405. In one implementation, the difference between the size of an object 230 in the first frame 305 and the size of the object 230 in the second frame 405 can be determined by measuring the changes of the dimensions of the object in pixels. The data processing system 110 or the computing device 115 may also determine the change in opacity of the object 230 by measuring the difference of the object's opacity value in the first frame 305 and the object's opacity value in the second frame 405.

For example, the content generation application 130 can determine the object 230′s position characteristic, rotation characteristic, size characteristic, and opacity characteristic or other characteristics in the first frame 305 and in the second frame 405. The content generation application 130 can compare the value of each characteristic of the object 230 in the first frame 305 with that in the second frame 405, and can calculate a delta or difference. For instance, if the values of the object 230's position characteristic are different between the two frames, the content generation application 130 may calculate the difference or delta and determine that the object 230 has a positional change metric with the delta calculated. If there is no difference, the content generation application 130 may determine the object 230 has a positional change metric of zero value. The object 230 may have none or one or multiple non-zero characteristic deltas.

In one implementation, the content generation application 130 identifies or determined the existence of a delta or difference between frame X−1 (e.g., first frame 305) and frame X (e.g., second frame 405) by reading the animatable properties of at least one (or each) object in frame X−1 and in frame X, and comparing the properties. When, for example, an object has identical properties in both frames, the content generation application 130 does not generate an animation instruction. When an object has differences in properties between the two frames, the content generation application generates a delta or set of deltas identifying the differences for those properties of the object.

In one implementation, the data processing system 110 or the computing device 115, in executing the content generation application 130, may generate an animation instruction based on the difference between the characteristics of the objects in frames. The animation instructions can include commands used to create motion, animation, or changes in object size, shape, form, or appearance in animated content items. For example, the content item placement module 135 or the computing device 115 may generate a movement or translation command, a rotation command, a scale command, an opacity command, or other animation instructions.

In one implementation, based on the difference or delta of each characteristic of the object 230 between the first frame 305 and the second frame 405, the content generation application 130 may generate corresponding animation instructions. For example, if the object 230 has a positional change metric that is a non-zero value, a movement or translation command can be generated. For example, if the object 230 has a rotational change metric that is a non-zero value, a rotation command can be generated. For example, if the object 230's size change metric has a non-zero value, a scale command can be generated. For example, if the object 230 has an opacity change metric that is a non-zero value, an opacity command can be generated. Other commands may be generated based on other characteristics such as changes in properties of the object 230. In some implementations, each animatable property or properties corresponds to at least one animation instruction or command. For example, (x, y, z) deltas between objects in frames can correspond to a translate command, width or height deltas can correspond to a scale command, rotation deltas can correspond to a rotate command, or opacity deltas can correspond to a fade command.

As an example, if the data processing system 110 or the computing device 115 determines a difference in the vector distance between the position of the car 230(c) in the first frame 305 and the position of the car 230(c) in the second frame 405, the data processing system 110 or the computing device 115 may determine the car 230(c) has a non-zero positional change metric. Based on this non-zero positional change metric, the data processing system 110 or the computing device 115 can generate a movement or translation command that imparts motion to the car 230(c) between the first position of the car 230 in the first frame 305 and the second position of the car 230 in the second frame 405 during display of an animated content item, which is generated by the content generation application 130 from the first frame 305 and the second frame 405.

In another example, based on position information of at least a portion of an object 230 in the first frame 305 and second frame 405, the content generation application 130 can determine that at least a portion of the object 230 rotates between these two frames, and can generate a rotation command. In another example, if the length, width, or height of the object 230 changes between frames, the content generation application 130 can determine the size of the object 230 changes and generate a scale command. In another example, the content generation application 130 can generate an opacity command when the opacity of the object 230 changes between frames.

In one implementation, the data processing system 110 or the computing device 115, in executing the content generation application 130, may generate an animated content item using the animation instruction. For example, if the object 230 has a translation command with a delta of 30 pixels in the X direction and a delta of 20 pixels in the Y direction, the data processing system 110 or the computing device 115 can generate an animated content item in which the object 230 can move from (X, Y) coordinates in the first frame 305 to the (X+30 pixels, Y+20 pixels) coordinates in the second fame 405. For example, if the object 230 has a rotation command with a rotational distance of 10 pixels in relation to a midpoint, the data processing system 110 or the computing device 115 can generate an animated content item in which the object 230 can rotate 10 pixels in relation to the midpoint. For example, if the object 230 has a scale command with a length delta of 15 pixels and a width delta of 5 pixels, the data processing system 110 or the computing device 115 can generate an animated content item in which the object 230 can be enlarged by 15 pixel in length and 5 pixel in width. For example, if the object 230 has an opacity command with an opacity value of 1 in the first frame and an opacity value of 0 in the second frame, the data processing system 110 or the computing device 115 can generate an animated content item in which the object 230 can fade to transparent in the second frame 405. Other animated content items can be generated based on other animation instructions.

In one implementation, the animated content item can include an animated sequence where characteristics of the objects 230 (e.g., size, shape, position, color, or opacity) change during a time period. For example, in a ten second time period, objects 230 in the animated content item may move from their positions in the first frame 305 to their positions in the second frame 405. The content generation application 130 can generate the animated content items from more than two frames. For example, intermediate frames can be generated between a first frame and a last frame that include objects 230 in intermediary positions.

In one implementation, a user (e.g., content provider) of the computing device 115 who is satisfied with the second frame 405 can click the preview input 240 to preview the animated content item. For example, the animated content item can be displayed in the interface area 220. In one implementation, the content provider or other user of the computing device 115 can access the submit interface or input 245 to indicate that all frames have been provided to the content generation application 130. The content generation application 130 can identify objects and their characteristics, and based on differences in these characteristics between frames, can generate the animated content item and store it, for example, in the database 140 or a data storage unit of the computing device 115.

In one implementation, the content generation application 130 can execute a script (e.g., JavaScript™) to generate animated instructions in a Cascading Style Sheet (CSS) markup or other style sheet. The generated style sheet can be utilized with a markup language, such as HTML, Extensible Markup Language (XML), or Extensible HyperText Markup Language (XHTML), to generate the animated content item to be displayed at a computing device.

For example, the car object 230(c) can be represented as an element in HTML: <div class=“car_object”> </div>

Continuing with the example, the content generation application 130 can generate a data structure property set, for example in JavaScript™, from the delta of the characteristics of the car object 230(c) in the first frame 305 and the characteristics of the car object 230(c) in the second frame 405. For instance, if the X coordinate of the position characteristic of the car object 230(c) is at 50 pixels in the first frame 305 and is at 80 pixels at the second frame 405, in one implementation, a data structure representing the position characteristic of the car object 230(c) can be generated, for example in JavaScript™, as:

```
{
  value: “x”,
  from: “50px”,
  to: “80px”
}
```

For example, if the value of the opacity characteristic of the car object 230(c) in the first frame 305 is 1 and the opacity characteristic of the car object 230(c) in the second frame 405 is 0.5, in one implementation, a data structure property set representing the opacity characteristic of the car object 230(c) can be generated as:

```
{
  value: “opacity”,
  from: “1”,
  to: “0.5”
}
```

Continuing with the example, in one implementation, an animation in CSS for the car object 230(c) can be generated as:

```
. car_object {
  animation: scene1scene2 2s ease-in;
}
@keyframes scene1scene2 {
0% {
    transform: translateX(50px);
    opacity: 1;
  }
100% {
    transform: translateX(80px);
    opacity: 0.5;
  }
}
```

In the above example, the animation for the car_object has a name of scene1scene2, a duration of 2 s (e.g., the animation takes 2 seconds from start to finish), a timing-function (e.g., the speed curve of the animation) of “ease-in” (e.g., the animation has a slow start). The animation may have other properties, such as delay, iteration-count, or direction, for example. Each property may have different values. For example, in addition to “ease-in”, the timing-function may have values such as “linear” (e.g., the animation has the same speed from start to end), “ease” (e.g., the animation has a slow start, then fast, before it ends slowly), “ease-out” (e.g., animation has a slow end), “ease-in-out” (e.g., animation has both a slow start and a slow end), or cubic-bezier (e.g., users can define their own values in a cubic-bezier function), for example.

Continuing with the above example, the @keyframes rule in CSS can create the animation scene1scene2. By specifying a CSS style inside the @keyframes rule, the animation may gradually change from the current style (e.g., at 0%) to the new style (e.g., at 100%). In this example, at the beginning of the animation (e.g., 0%), the car_object is at X coordinate of 50px and with an opacity value of 1. At the end of the animation (e.g., 100%), the car_object is at X coordinate of 80px with an opacity value of 0.5. As a result, when animation scene1scene2 is utililized with HTML for example, the car_object can move from left to right and fade during the display of the animation.

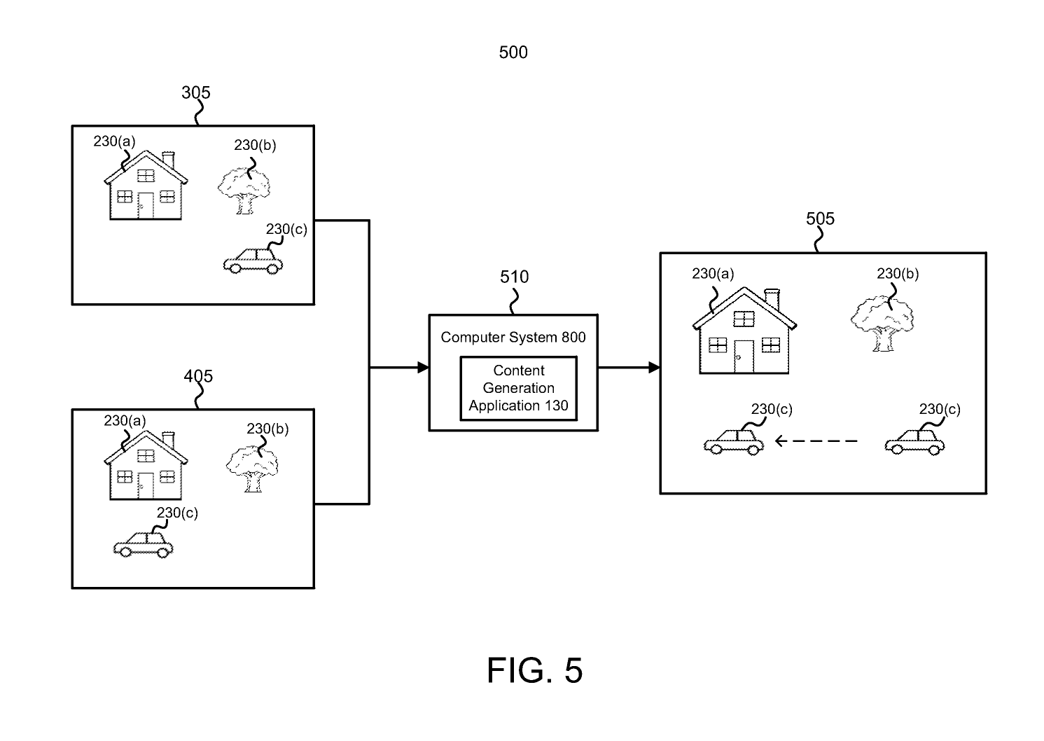

FIG. 5 is a block diagram illustrating an example animated content item 505 created by the computer system 800, which as described further herein can include the data processing system 110 or the computing device 115 that executes the content generation application 130 to generate an animated content item 505. For example, the animated content item 505 can be generated by the content generation application 130 upon actuation of the preview input 240 is received or by any of the data processing system 110, the content publisher 120, or the client computing device 125 for display of the animated content item at the client computing device 125. In this example, the computer system 800 can execute the content generation application 130 to determine characteristics of the objects 230 in the first frame 305 and the second frame 405. For example, the computer system 800 can execute the content generation application 130 to determine that a location characteristic of the car object 230(c) in the first frame 305 and the second frame 405 is different. Using this difference, the content generation application 130 in this example can generate an animation instruction (e.g., a movement or translation command) that imparts motion to the car object 230(c) during display of the animated content item 505 at the client computing device 125. In this example, the car object 230(c) moves during display of the animated content item 505, as indicate by the arrow in the animated content item 505 of FIG. 5.

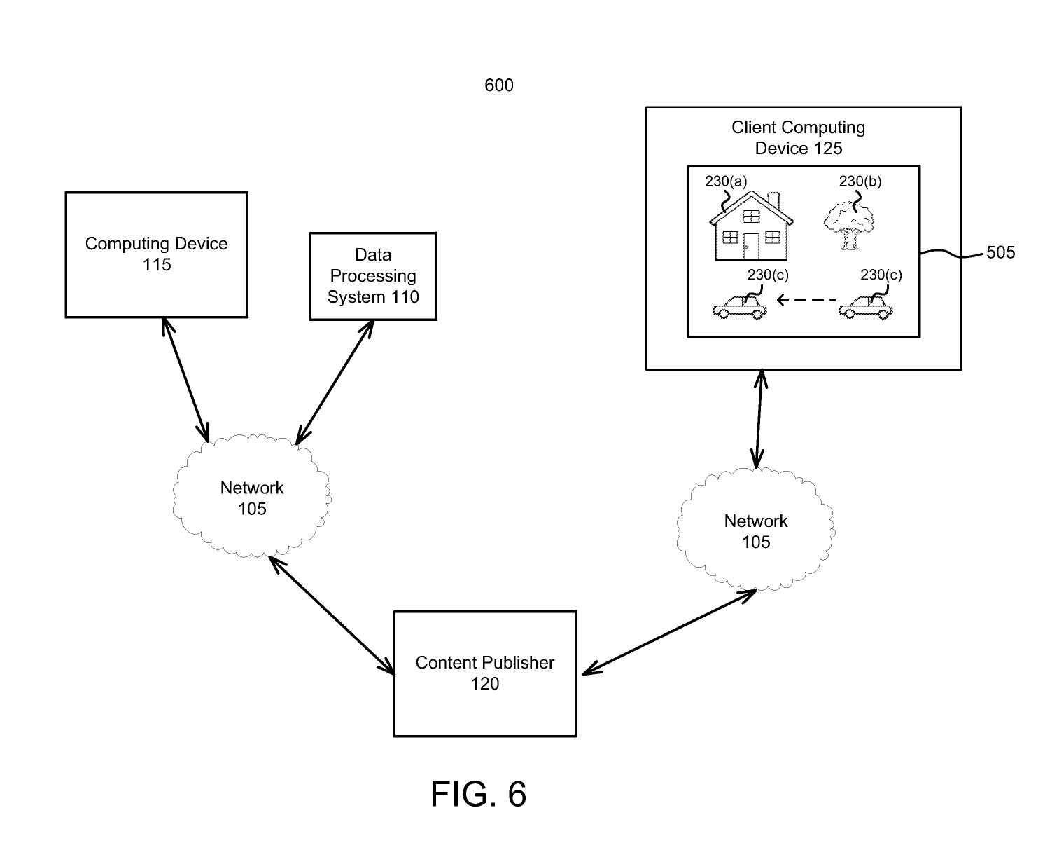

The animated content items (e.g., the animated content item 505) can be provided for display on client computing devices 125, for example as part of an online content item placement or ad placement campaign undertaken by the content provider using the computing device 115 and the data processing system 110. Referring to FIG. 6, the client computing device 125 can communicate via the network 105 with the content publisher 120 to view an information resource such as a web page generally controlled by the content publisher 120. The content publisher 120, via the network 105, can communicate with the data processing system 110 to request an animated content item to provide for display with the web page (or other content) at the client computing device 125. The data processing system 110 (e.g., the content item placement module 135) can select the animated content item 505 (e.g., from the database 140 not shown in FIG. 6 or from the computing device 115) and can provide (or instruct the computing device 115 to provide) the animated content item 505 to the content publisher 120, or to the client computing device 125, for display in an information resource at the client computing device 125.

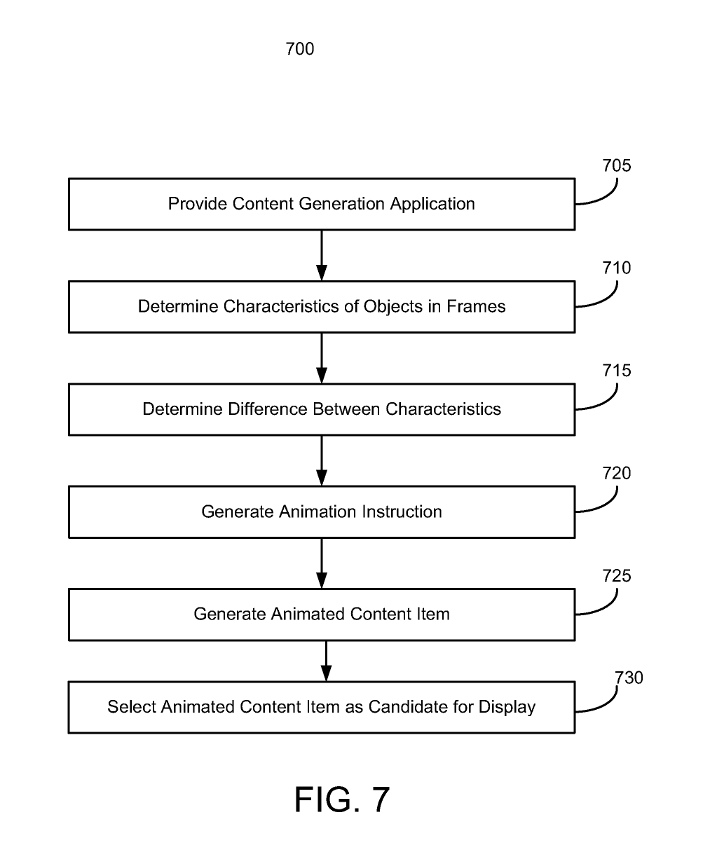

FIG. 7 is a flow diagram depicting an example method 700 of creating animated content items. In brief overview, method 700 can include providing a content generation application from a data processing system to a computing device via the computer network (BLOCK 705). For example, the content generation application can have at least one interface configured to prompt for a first frame and a second frame. The method 700 can include determining, by one of the data processing system and the computing device, a characteristic of an object in the first frame and the characteristic of the object in the second frame (BLOCK 710). The method 700 can further include determining a difference between the characteristic of the object in the first frame and the characteristic of the object in the second frame (BLOCK 715). The method 700 can additionally include generating an animation instruction based on the difference between the characteristic of the object in the first frame and the characteristic of the object in the second frame (BLOCK 720), and generating an animated content item using the animation instruction (BLOCK 725).

In further detail, method 700 can include providing a content generation application from a data processing system to a computing device via the computer network (BLOCK 705). For example, a computing device can make a request to the data processing system for creating animated content items via the computer network. In one implementation, responsive to the request, a content item placement module of the data processing system can provide the content generation application to the computing device via the computer network. The content generation application can have one or more interfaces configured to prompt for the entry of frames.

In some implementations, the method 700 can include determining, by one of the data processing system and the computing device, a characteristic of an object in the first frame and the characteristic of the object in the second frame (BLOCK 710). For example, a frame or a scene can include a drawing or image which defines the starting, intermediary, or ending point of an animation sequence of the animated content item. A frame can include multiple objects, for example a house, a tree, and a car that make up the drawing. In one implementation, characteristics of the object can include a position characteristic, a rotation characteristic, a size characteristic, an opacity characteristic, etc. For example, an object's position in a frame can be determined on a pixel basis by its X and Y Cartesian coordinates in the frame.

In some implementations, the method 700 can include determining a difference between the characteristic of the object in the first frame and the characteristic of the object in the second frame (BLOCK 715). For example, the difference may include a positional change metric, a rotational change metric, a size change metric, or an opacity change metric. For instance, the data processing system or the computing device may determine a vector distance between a car object in the first frame and the car object in the second frame.

In some implementations, the method 700 can include generating an animation instruction based on the difference between the characteristic of the object in the first frame and the characteristic of the object in the second frame (BLOCK 720). For example, the content item placement module of the data processing system or the computing device may generate commands, such as a movement or translation command, a rotation command, a scale command, or an opacity command. For instance, if the content item placement module or the computing device determines a vector distance between the position of a car object in the first frame and the position of the car object in the second frame, the content item placement module or the computing device may generate a movement or translation command.

In some implementations, the method 700 can include generating an animated content item using the animation instruction (BLOCK 725). For example, based a movement or translation command, the content item placement module of the data processing system or the computing device may generate an animated content item including a sequence of animated movement. For instance, a movement or translation command for a car object may be used to generate an animated content item in which the car object moves from one position to a different position in the frame. In one implementation, the content item placement module or the computing device generates the animated content item using a style sheet language, such as a Cascading Style Sheet language. The method 700 can select the animated content item as a candidate for display (BLOCK 730) by the client computing device, for example as part of an online content item placement campaign. For example, the data processing system or a component thereof such as the content item placement module can determine that the animated content item is suitable (e.g., based on partial content matching or a bid value) for display with a web page or other online document by the client computing device. In this example, the data processing system can select (BLOCK 730) the animated content item as a candidate for display. The selected content item can be entered into an auction, for example, where a winning content item from the auction is provided (e.g., by the data processing system or the computing device) for display at the client computing device.

FIG. 8 shows the general architecture of an illustrative computer system 800 that may be employed to implement any of the computer systems discussed herein (including the system 100 and its components such as the data processing system 110, the content generation application 130 and the content item placement module 135) in accordance with some implementations. The computer system 800 can be used to create animated content items via the network 105. The computer system 800 of FIG. 8 comprises one or more processors 820 communicatively coupled to memory 825, one or more communications interfaces 805, and one or more output devices 810 (e.g., one or more display units) and one or more input devices 815. The processors 820 can be included in data processing system 110 or the other components of the system 100 (such as the content item placement module 135, the computing device 115, the content publisher 120 or the client computing device 125).

In the computer system 800 of FIG. 8, the memory 825 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, the content item placement module 135, the database 140, the computing device 115, the content publisher 120, or the client computing device 125 can include the memory 825 to store animated content items. The processor(s) 820 shown in FIG. 8 may be used to execute instructions stored in the memory 825 and, in so doing, also may read from or write to the memory various information processed and or generated pursuant to execution of the instructions.

The processor 820 of the computer system 800 shown in FIG. 8 also may be communicatively coupled to or control the communications interface(s) 805 to transmit or receive various information pursuant to execution of instructions. For example, the communications interface(s) 805 may be coupled to a wired or wireless network, bus, or other communication means and may therefore allow the computer system 800 to transmit information to and/or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 800. Examples of communications interfaces 805 include user interfaces (e.g., web pages) having content (e.g., animated advertisements) selected by the content item placement module 135 and provided by the computing device 115 for placement on the web pages.

The output devices 810 of the computer system 800 shown in FIG. 8 may be provided, for example, to allow various information to be viewed or otherwise perceived in connection with execution of the instructions. The input device(s) 815 may be provided, for example, to allow a user to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

For situations in which the systems discussed herein collect personal information about users, or may make use of personal information, the users may be provided with an opportunity to control whether programs or features that may collect personal information (e.g., information about a user's social network, social actions or activities, a user's preferences, or a user's current location), or to control whether or how to receive content from a content server of other data processing system that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by the content server.

The term “data processing apparatus” or “computing device” “module” “engine” or “computing device” encompasses apparatuses, devices, and machines for processing data, including by way of example a programmable processor, a computer, a system on a chip, or multiple ones, or combinations, of the foregoing. The apparatuses can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The content item placement module 135 or the computing device 115 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 800 or system 100 can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

The implementation details described herein should not be construed as limitations on the scope of what may be claimed, but rather as descriptions of features specific to particular implementations of the systems and methods described herein. Certain features that are described in this specification in the context of separate implementations can also be implemented in combination in a single embodiment or implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, content item placement module 135 or the computing device 115 can be a single module, a logic device having one or more processing circuits, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, the computing device 115 can include personal computers (e.g., desktops, laptops, tablets, smartphones, or personal digital assistants) used by a user such as a content provider at any locations to create animated content items. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of creating animated content items via a computer network for display at computing devices as part of an online content item placement campaign, comprising:
providing a content generation application from a data processing system to a computing device via the computer network, the content generation application having at least one interface configured to prompt for a first frame and a second frame;
determining by one of the data processing system and the computing device, a characteristic of an object in the first frame and the characteristic of the object in the second frame;
determining a difference between the characteristic of the object in the first frame and the characteristic of the object in the second frame;
generating, by the content generation application during execution of the content generation application by at least one of the data processing system and the computing device, an animation instruction based on the difference between the characteristic of the object in the first frame and the characteristic of the object in the second frame;
generating, using the animation instruction, an animated content item; and
selecting the animated content item as a candidate for display by a client computing device as part of the online content item placement campaign.

2. The method of claim 1, further comprising:
determining that at least one of the characteristic of the object in the first frame and the characteristic of the object in the second frame includes at least one of an object position characteristic, an object rotation characteristic, an object size characteristic, and an object opacity characteristic.

3. The method of claim 1, wherein determining the difference between the characteristic of the object in the first frame and the characteristic of the object in the second frame further comprises:
determining at least one of a positional change metric, a rotational change metric, a size change metric, and an opacity change metric.

4. The method of claim 1, further comprising:
generating the animation instruction, wherein the animation instruction includes at least one of a translation command, a rotation command, a scale command, and an opacity command.

5. The method of claim 1, further comprising:
generating the animated content item based on the animation instruction using a style sheet language.

6. The method of claim 1, further comprising:
determining a first location of the object in the first frame;
determining a second location of the object in the second frame;
determining a distance between the first location and the second location; and
generating the animation instruction based on the distance.

7. The method of claim 6, further comprising:
using the animation instruction to animate the object to move between the first location and the second location during display of the animated content item by a computing device.

8. The method of claim 1, further comprising:
providing the animated content item from the data processing system via the computing network for display by the client computing device responsive to a request for content received by the data processing system.

9. The method of claim 1, wherein the at least one interface includes a frame entry interface and a preview interface.

10. The method of claim 1, wherein the content generation application prompts for the second frame subsequent to the first frame.

11. The method of claim 1, further comprising:
receiving, by the data processing system via the computer network, a request to create at least one animated content item as part of the online content item placement campaign.

12. A system of creating animated content items via a computer network for display at computing devices as part of an online content item placement campaign, comprising:
a data processing system configured to provide a content generation application to a computing device, the content generation application having at least one interface configured to prompt for a first frame and a second frame and the content generation application configured to:
determine a characteristic of an object in the first frame and the characteristic of the object in the second frame;
determine a difference between the characteristic of the object in the first frame and the characteristic of the object in the second frame;
generate, by the content generation application during execution of the content generation application by at least one of the data processing system and the computing device, an animation instruction based on the difference between the characteristic of the object in the first frame and the characteristic of the object in the second frame; and
generate an animated content item using the animation instruction; and
the data processing system configured to select the animated content item as a candidate for display by a client computing device as part of the online content item placement campaign.

13. The system of claim 12, further comprising:
the content generation application configured to determine that at least one of the characteristic of the object in the first frame and the characteristic of the object in the second frame includes at least one of an object position characteristic, an object rotation characteristic, an object size characteristic, and an object opacity characteristic.

14. The system of claim 12, further comprising:
the content generation application configured to determine at least one of a positional change metric, a rotational change metric, a size change metric, and an opacity change metric.

15. The system of claim 12, further comprising:
the content generation application configured to generate the animation instruction including at least one of a translation command, a rotation command, a scale command, and an opacity command.

16. The system of claim 12, further comprising:
the content generation application configured to generate the animated content item based on the animation instruction using a style sheet language.

17. The system of claim 12, further comprising:
the data processing system configured to provide the animated content item via the computing network for display by the client computing device responsive to a request for content received by the data processing system.

18. A computer readable storage medium storing instructions that when executed by one or more data processors, cause the one or more data processors to perform operations for creating animated content items for display at computing devices as part of an online content item placement campaign, the operations comprising:
providing a content generation application having at least one interface configured to prompt for a first frame and a second frame;
determining a characteristic of an object in the first frame and the characteristic of the object in the second frame;
determining a difference between the characteristic of the object in the first frame and the characteristic of the object in the second frame;
generating, by the content generation application and during execution of the content generation application by at least one of a data processing system and a computing device, an animation instruction based on the difference between the characteristic of the object in the first frame and the characteristic of the object in the second frame;
generating, using the animation instruction, an animated content item; and
selecting the animated content item as a candidate for display by a client computing device as part of the online content item placement campaign.

19. The computer readable storage medium of claim 18, wherein the instructions that when executed by the one or more data processors, cause the one or more data processors to perform operations comprising:
determining a first location of the object in the first frame;
determining a second location of the object in the second frame;
determining a distance between the first location and the second location; and
generating the animation instruction based on the distance.

20. The computer readable storage medium of claim 18, wherein the instructions that when executed by the one or more data processors, cause the one or more data processors to perform operations comprising:
using the animation instruction to animate the object to move between the first location and the second location during display of the animated content item by a computing device.
